(19) United States
(12) Patent Application Publication
(10) Pub. No.: US 2025/0333124 A1
(43) Pub. Date: Oct. 30, 2025

(54) DEBRIS MITIGATION APPARATUS FOR TRACKED VEHICLES

(71) Applicant: Deere & Company, Moline, IL (US)

(72) Inventor: David Robison, Asbury, IA (US)

(21) Appl. No.: 18/651,083

(22) Filed: Apr. 30, 2024

(51) Int. Cl. B62D 55/10; B62D 55/06; B62D 55/12; B62D 55/14; B62D 55/20; B62D 55/26; E02F 9/02

(52) U.S. Cl. CPC B62D 55/10; B62D 55/06; E02F 9/02; B62D 55/12; B62D 55/14; B62D 55/20; B62D 55/26

(57) ABSTRACT

A utility vehicle comprising a ground engagement element movably supported by a frame and driven by a motor to drive movement of the utility vehicle, wherein the ground engagement element comprises a plurality of track shoes, a plurality of track links, a drive sprocket, an idler wheel, a roller, and a lower frame, wherein a portion of the lower frame is coupled with a low coefficient of friction material, wherein the low coefficient of friction material comprises a debris shield coupled to the portion of the lower frame with one or more of (a) fasteners and (b) adhesive.

### TECHNICAL FIELD

The present disclosure relates generally to utility vehicles. More specifically, this disclosure relates to utility vehicles with drivetrains that include tracks.

### BACKGROUND

Vehicles with track drivetrains often operate in areas that can generate a lot of debris, including dirt and mud, that can accumulate on portions of the undercarriage and drivetrain that is proximate the tracks where that debris can become stuck and/or accumulate. Accumulated debris can hinder and/or degrade performance of the tracks and undercarriage components and impede maintenance of specific areas of the vehicle. Reducing the debris in/around the tracks is desired. Existing solutions include metal shields to deter rocks and debris from entering the track system but do not prevent dirt and mud from accumulating and/or aid or ease removal of the debris.

### SUMMARY

According to an aspect of the present disclosure, a utility vehicle can comprise a ground engagement element movably supported by a frame and driven by a motor to drive movement of the utility vehicle, wherein the ground engagement element comprises a plurality of track shoes, a plurality of track links, a drive sprocket, an idler wheel, a roller, and a lower frame, wherein a portion of the lower frame is coupled with a low coefficient of friction material.

According to another aspect of the present disclosure, aground engagement element for a utility vehicle can comprise a plurality of track shoes, a plurality of track links, a drive sprocket, an idler wheel, a roller, and a lower frame, wherein a portion of the lower frame is coupled with a low coefficient of friction material.

In yet another aspect of the present disclosure, a tracked vehicle can comprise a lower frame, wherein the lower frame comprises a first top surface and a second top surface is adjacent to the first top surface, wherein each of a first top surface section and a second top surface section is coupled with a low coefficient of friction material.

Other features and aspects will become apparent by consideration of the detailed description, claims, and accompanying drawings.

### BRIEF DESCRIPTION OF THE DRAWINGS

The detailed description of the drawings refers to the accompanying figures.

FIG. 1 is a perspective view of an excavator, consistent with embodiments of the present disclosure.

FIG. 2 is a side view of the drivetrain of the excavator of FIG. 1, with exemplary debris accumulated in the lower frame, consistent with embodiments of the present disclosure.

FIG. 3 is a perspective view of an excavator lower frame, consistent with embodiments of the present disclosure.

Like reference numerals are used to indicate like elements throughout the several figures.

### DETAILED DESCRIPTION

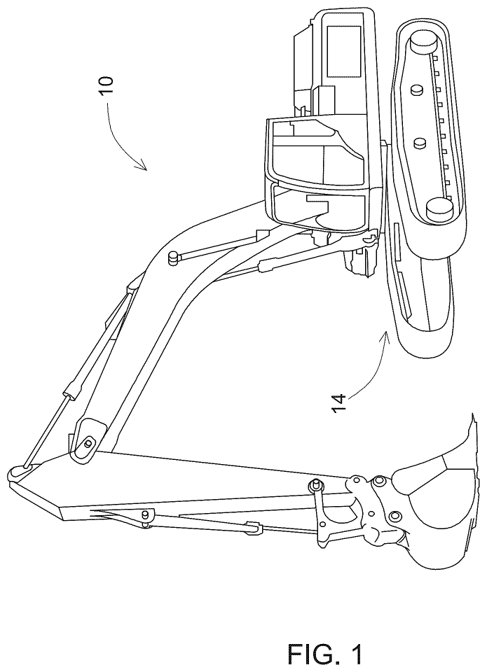

FIG. 1 is a perspective view of an excavator, consistent with embodiments of the present disclosure. An excavator 10 can include a ground engagement element 14 (e.g., tracks). The tracks 14 can include various elements (described in greater detail below).

While an excavator is shown and described here, this disclosure is not limited to an excavator, but can be applied to any utility vehicle with tracks, including, but not limited to, a crawler dozer, a crawler loader, a compact track loader, tractors (e.g., agricultural and construction), feller bunchers, and other similar vehicles.

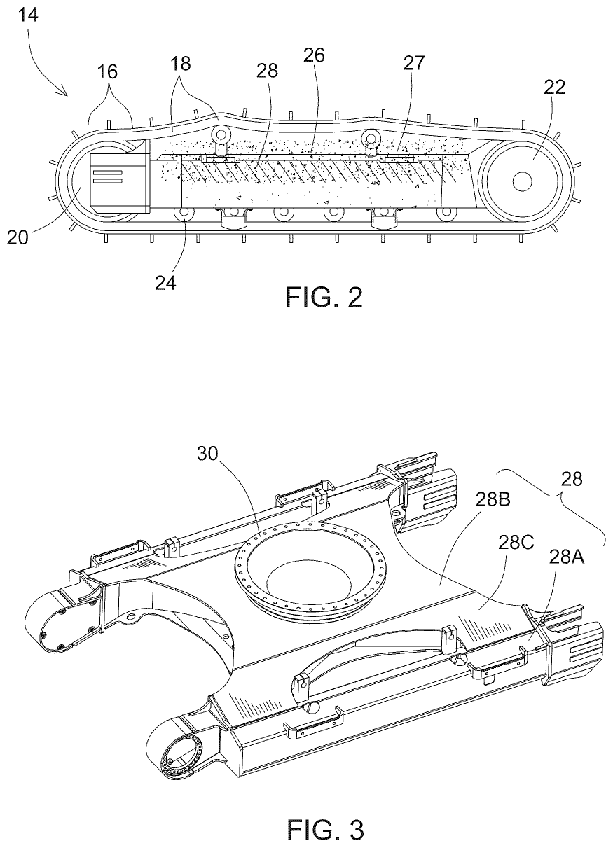

FIG. 2 is a side view of the drivetrain of the excavator of FIG. 1, with exemplary debris accumulated in the lower frame, consistent with embodiments of the present disclosure. The tracks 14 can include a plurality of track shoes 16, a plurality of track links 18, a drive sprocket 20, an idler wheel 22, a roller 24 (e.g., an upper or carrier roller and/or a lower or bottom roller). The drive sprocket 20, the idler wheel 22, and the roller 24 can be rotatably coupled to a lower frame 26, for example, via axles, bearings or other similar elements. Areas of the lower frame 26 and the tracks 14 can accumulate debris, including dirt and mud, that can become stuck. When dried, dirt and mud can be difficult to remove, which can hinder performance and maintenance and/or repairs of the excavator.

An excavator is the exemplary vehicle used in the embodiments described here, but as discussed above, numerous other vehicles with tracks could include the debris mitigation elements described herein. As different vehicles may refer to different elements with differing terminology, other variations of part names should be considered. For example, the excavator 10 here includes a lower frame 26. Other vehicles may not generally refer to or use the term “lower frame” but may have something similar such as a frame, a main frame, a chassis, a body, or other similar structure.

As shown in FIG. 2, debris 27 can accumulate around portions of the tracks 14 during operation of the excavator. A surface 28 of the lower frame 26 can be covered (e.g., coupled, coated, mated with, etc.) a material to help prevent accumulation of the debris and/or ease in the removal of the debris.

A material suitable to help prevent the accumulation of debris would be a material with a low coefficient of friction material. Coefficient of friction can be defined as a ratio of the frictional force resisting the motion of two surfaces in contact to the normal force pressing the two surfaces together. Coefficient of friction is often represented by the Greek letter mu (p). Coefficients of friction for combinations of various materials can include:

| | | Static Coefficient of | Static Coefficient of Friction |
|---|---|---|---|
| Material | Against Material | Friction (dry contact) | (lubricated contact) |
| Steel | Steel | 0.80 | 0.16 |
| Steel | PTFE | 0.05-0.20 | 0.04 |
| Nylon | Nylon | 0.15-0.25 | |
| PTFE | PTFE | 0.05-0.20 | 0.04 |
| Steel (316SS) | Rubber | 0.64 | |
| Rubber | Rubber | 1.15 | |
| Wood | Metals | 0.20-0.60 | 0.20 |

The above table is a small sample of various coefficients of friction between some materials and is not meant to be limiting for the options considered here. Any material with a suitable (low) coefficient of friction for the application encountered by a utility vehicle with tracks could be used to help solve the issues related to build up of materials/debris in and around the tracks.

Any material can be used for the debris shield that has a coefficient of friction lower than what is currently found between painted steel (currently used) and dirt, mud, or any other typical debris combination that can build up on the lower frame would be a suitable choice for an embodiment here.

PTFE is one of the materials that is very effective at resisting friction with many materials and would be a candidate for use in the embodiments described herein. Nylon and similar polymers may also be a useful in some applications of the embodiments here.

FIG. 3 is a perspective view of an excavator lower frame, consistent with embodiments of the present disclosure. The lower frame 26 can include a top plate 28 with various surfaces, including a surface (i.e., a first top surface 28A) that is further from a swing tower 30 and another surface (i.e., a second top surface 28B) that is closer (e.g., adjacent) from the swing tower 30. The top plate 28 can also include a third top surface 28C that is in between the first top surface 28A and the second top surface 28B. The first top surface 28A, the second top surface 28B, and the third top surface 28C can each be covered with a material that is a low coefficient of friction material. In some embodiments, a combination of those three surfaces are covered with the low coefficient of friction material (e.g., only one surface is covered (28A or 28B or 28C), or two of the three surfaces are covered (28A and 28B, 28A and 28C, 28B and 28C) or all three surfaces are covered (28A, 28B, and 28C).

Covering the surfaces 28A, 28B, and/or 28C can be achieved in any suitable way, including a piece of material (i.e., a debris shield) coupled with the first top surface 28A, the second top surface 28B, and/or the third top surface 28C using fasteners, adhesive, or a combination of fasteners and adhesive.

Covering a surface can be achieved by multiple pieces of material or a single piece. Another method of covering the first top surface, the second top surface, and or the third top surface is to apply a coating (e.g., spraying, painting, CVD, or any other suitable method for applying coatings). The methods/materials used to coat each of the first top surface, the second top surface, and or the third top surface can be different (e.g., the first top surface could have a piece of low coefficient of friction material attached with fasteners, the second top surface could have low coefficient of friction material applied through a coating, and the third top surface could have a piece of low coefficient of friction material attached with adhesive).

In some embodiments only a portion of the first top surface 28A may be covered with the low coefficient of friction material. And/or a portion of the second top surface 28B, and/or a portion of the third top surface 28C. The portions of surfaces 28A-C including a low coefficient of friction material can be mixed and matched in any combination of full and partial coverage by the low coefficient of friction material (e.g., (1) a portion of 28A is covered, all of 28B, a portion of 28C is covered, (2) all of 28A is covered, all of 28B is covered, a portion of 28C is covered, etc.).

As used herein, “e.g.” is utilized to non-exhaustively list examples and carries the same meaning as alternative illustrative phrases such as “including,” “including, but not limited to,” and “including without limitation.” Unless otherwise limited or modified, lists with elements that are separated by conjunctive terms (e.g., “and”) and that are also preceded by the phrase “one or more of” or “at least one of” indicate configurations or arrangements that potentially include individual elements of the list, or any combination thereof. For example, “at least one of A, B, and C” or “one or more of A, B, and C” indicates the possibilities of only A, only B, only C, or any combination of two or more of A, B, and C (e.g., A and B; B and C; A and C; or A, B, and C).

Those having ordinary skill in the art will recognize that terms such as “above,” “below,” “upward,” “downward,” “top,” “bottom,” etc., are used descriptively for the figures, and do not represent limitations on the scope of the disclosure, as defined by the appended claims. Furthermore, the teachings may be described herein in terms of functional and/or logical block components and/or various processing steps. It should be realized that such block components may be comprised of any number of hardware, software, and/or firmware components configured to perform the specified functions.

Terms of degree, such as “generally”, “substantially” or “approximately” are understood by those of ordinary skill to refer to reasonable ranges outside of a given value or orientation, for example, general tolerances or positional relationships associated with manufacturing, assembly, and use of the described embodiments.

While the above describes example embodiments of the present disclosure, these descriptions should not be viewed in a limiting sense. Rather, other variations and modifications may be made without departing from the scope and spirit of the present disclosure as defined in the appended claims.

What is claimed is:

1. A utility vehicle comprising:
a ground engagement element movably supported by a frame and driven by a motor to drive movement of the utility vehicle, wherein the ground engagement element comprises:
a plurality of track shoes,
a plurality of track links,
a drive sprocket,
an idler wheel,
a roller, and
a lower frame, wherein a portion of the lower frame is coupled with a low coefficient of friction material.

2. The utility vehicle of claim 1, wherein the utility vehicle comprises an excavator, a crawler dozer, a crawler loader, a tractor, or a compact skid loader.

3. The utility vehicle of claim 1, wherein the low coefficient of friction material comprises a coating applied to the portion of the lower frame.

4. The utility vehicle of claim 1, wherein the low coefficient of friction material comprises a debris shield coupled to the portion of the lower frame with one or more of (a) fasteners and (b) adhesive.

5. The utility vehicle of claim 1, wherein the portion of the lower frame comprises a first top surface, a second top surface, and a third top surface.

6. The utility vehicle of claim 5, wherein the first top surface is further from a swing tower and the second top surface is close to the swing tower and proximate the swing tower of the lower frame, and the third top surface is in between the first top surface and the second top surface.

7. The utility vehicle of claim 1, wherein the low coefficient of friction material comprises a material with a static friction coefficient of 0.25 or less.

8. A ground engagement element for a utility vehicle comprising:
a plurality of track shoes,
a plurality of track links,
a drive sprocket,
an idler wheel,
a roller, and
a lower frame, wherein a portion of the lower frame is coupled with a low coefficient of friction material.

9. The ground engagement element for the utility vehicle of claim 8, wherein the low coefficient of friction material comprises a coating applied to the portion of the lower frame.

10. The ground engagement element for the utility vehicle of claim 8, wherein the low coefficient of friction material comprises a debris shield coupled to the portion of the lower frame with one or more of (a) fasteners and (b) adhesive.

11. The ground engagement element for the utility vehicle of claim 8, wherein the portion of the lower frame comprises a first top surface and a second top surface.

12. The ground engagement element for the utility vehicle of claim 11, wherein the first top surface is closer to and proximate a swing tower coupled with the lower frame and the second top surface is further from the swing tower and wherein the first top surface is adjacent to the second top surface.

13. The ground engagement element for a utility vehicle of claim 8, wherein the low coefficient of friction material comprises a material with a static friction coefficient of 0.25 or less.

14. A tracked vehicle comprising:
a lower frame, wherein the lower frame comprises:
a first top surface, and
a second top surface is adjacent to the first top surface,
wherein each of a first top surface section and a second top surface section is coupled with a low coefficient of friction material.

15. The tracked vehicle of claim 14, wherein the first top surface is closer to and proximate a swing tower coupled with the lower frame and the second top surface is further from the swing tower.

16. The tracked vehicle of claim 14, wherein the low coefficient of friction material comprises a material with a static friction coefficient of 0.25 or less.

17. The tracked vehicle of claim 14, wherein the low coefficient of friction material comprises a coating applied to the portion of the lower frame.

18. The tracked vehicle of claim 14, wherein the low coefficient of friction material comprises a debris shield coupled to the portion of the lower frame with one or more of (a) fasteners and (b) adhesive.
